(19) United States
(12) Patent Application Publication
(10) Pub. No.: US 2007/0263067 A1
(43) Pub. Date: Nov. 15, 2007

(54) Slide mobile camera phone

(75) Inventors: Cheng-Wen Huang, Taipei (TW); Shun-Yi Lian, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/430,838

(22) Filed: May 10, 2006

(51) Int. Cl. H04N 7/14

(52) U.S. Cl. 348/14.01

(57) ABSTRACT

A slide mobile camera phone comprises a display part and an operation part. The display part comprises a viewing side and a joining side, and the joining side further comprises a camera lens. The operation part comprises an operating side and a back side, and the operating side further comprises a set of zoom lenses, wherein the joining side is able to slide on the back side so that the display part and the operation part can either essentially totally or partially overlap. If the display part and the operation part partially overlap, then the camera lens is configured to capture images directly; and if the display part and the operation part essentially totally overlap and the camera lens overlaps the set of zoom lenses, then the camera lens is configured to capture images after zooming via the set of zoom lenses.

### BACKGROUND OF THE INVENTION

(1) Field of the Invention

The present invention relates to a slide mobile camera phone which can be used to take photos, especially to the mobile camera phone that can zoom the camera lens manually.

(2) Description of the Prior Art

In early stages of mobile phone developing, the innovation of mobile phones is usually about signal communication technique, semiconductor process, and chip technique. The first generation of mobile phone is analog transmission phone, the second generation of mobile phone is digital transmission phone, and nowadays the GPRS phone and 3 G phone are growing quickly.

Base on the research of InfoTrends Research Group, in 2004, the colored mobile phone takes 20% of the total mobile phone sale volume (near to 1.5 hundred million) and the group predicts that the sale amount of colored mobile phone will arrive 6.56 hundred million till 2008. The sensitization element in the colored mobile phone are usually CCD array or CMOS array.

CMOS (Complementary Metal Oxide Semiconductor) is a charged-semiconductor which uses Si and Ge elements to contain positive and negative charges. The electric currents due by complementary effect can be recorded as an image. The CMOS can exist on the chip that the same as the image processing circuit. The advantage of CMOS is low-cost, low power consumption. But while processing the image quickly, the high frequency change of current will occur grey point because the high temper.

CCD (Charge Coupled Device) is a semiconductor which can record changes of light. The surface of CCD is an electronic pattern, while the surface sensing light, the signal sensed by the pattern compose a complete image.

Please refer to FIG. 1, which is a prior art of a mobile camera phone which is configured to take photos. The mobile camera phone 1 comprises a display monitor 11, a set of keys 12, a camera lens 13, and a flash button 14. While a user wants to take photos of an object by the mobile camera phone 1, he just has to face the camera lens 13 to the object and to regulate the distance between the camera lens and the object to obtain a clear image on the monitor 11, then pressing the flash button 14 to get the photo. The camera lens 13 can be a CCD lens or a CMOS lens.

The focal length of the camera lens 13 is usually fixed. It means that users can't regulate the focus length while taking photos. Some mobile camera phones have a function of “digital focus-zooming”, which is achieved by some programs, but the function of digital focus-zooming can't improve the real dots per inch.

It's not difficult to assemble optical lens which can zoom focus, but consequently the size of this kind of phones is as bigger as a real camera. The development of mobile camera phones is getting thinner and smaller, no one wants to buy a mobile camera phone as big as a camera. How to improve the focus-zooming problem without raising the size and the cost too much is important for business policy.

The other problem in camera phones is power consumption. A three hundred thousand pixels camera phone consumes 1.5 W power while talking or taking photos. But a camera phone with pixels higher than millions will consume power exceeding 2 W and lower the battery time from 6 hour (1.5 W) to 1˜2 hours (2 W). Hence, the power consumption is also an problem while using a better camera lens in a mobile phone.

### SUMMARY OF THE INVENTION

The object of the present invention is to provide a slide mobile camera phone comprising a manually-operated camera lens.

Accordingly, the invention provides a slide mobile camera phone, which comprises a display part and an operation part. The display part comprises a viewing side and a joining side, and the joining side further comprises a camera lens. The operation part comprises an operating side and a back side, and the operating side further comprises a set of zoom lenses, wherein the joining side is able to slide on the back side so that the display part and the operation part can either essentially totally or partially overlap.

If the display part and the operation part partially overlap, then the camera lens is configured to capture images directly; and if the display part and the operation part essentially totally overlap and the camera lens overlaps the set of zoom lenses, then the camera lens is configured to capture images after zooming via the set of zoom lenses.

The zoom lens herein can be a simple convex lens or a composite converging lens. By composing of a plurality of convex and concave lenses to adjust the aberration problem caused by only one lens a better imaging quality can be obtained.

### BRIEF DESCRIPTION OF THE DRAWINGS

The present invention will now be specified with reference to its preferred embodiment illustrated in the drawings, in which

FIG. 1 is a prior art of a mobile camera phone; (prior art)

FIG. 2A shows one lateral view of an embodiment of the present invention;

FIG. 2B shows another lateral view of an embodiment of the present invention.

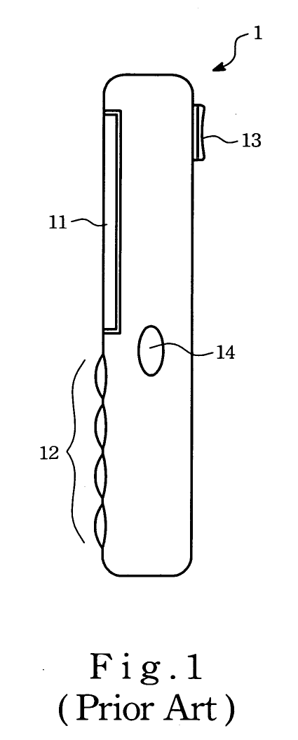

### DESCRIPTION OF THE PREFERRED EMBODIMENT

As problems mentioned in the background, improving the camera effect and keeping the low cost and low power consumption are important and necessary.

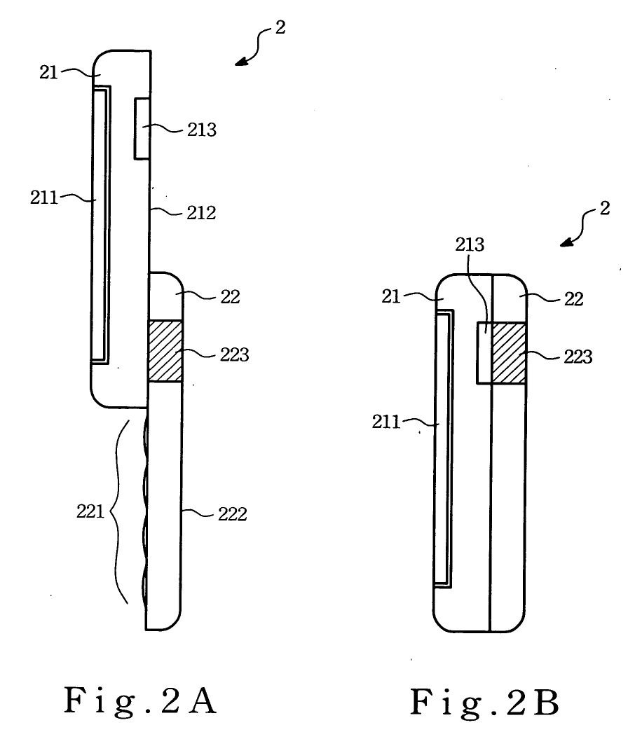

The present invention discloses a slide mobile camera phone, please refer to FIG. 2A˜2B, which show the lateral view of an embodiment of the present invention. The slide mobile camera phone in FIG. 2A˜2B comprises a display part 21 and an operation part 22. The display part 21 comprises a viewing side 211 and a joining side 212, and the joining side 212 further comprises a camera lens 213.

The operation part 22 comprises an operating side 221 and a back side 222, and the operating side 222 further comprises a set of zoom lenses 223. The joining side 212 is able to slide on the back side 222 so that the display part and the operation part either essentially totally or partially overlap (while slide up). As shown, the operating side 221 comprises a set of keys.

When the display part and the operation part partially overlap (shown as FIG. 2A), the camera lens is configured to capture images directly and the user can view photo images in the monitor 211.

But while the display part and the operation part essentially totally overlap and the camera lens overlaps the set of zoom lenses (shown in FIG. 2B), the camera lens is configured to capture images after zooming via the set of zoom lenses. Thus the goal of zooming focus without power consumption caused by applying the optical zoom for the image pixel enhancement can be achieved.

The camera lens herein can be CCD lens or CMOS lens. Whatever kinds of lenses being used, by adding a zoom lens the goal of zooming focus can be achieved.

The zoom lens in the present invention can be a simple convex lens or a composite converging lens. By composing of a plurality of convex and concave lenses to adjust the aberration problem caused by only one lens a better imaging quality can be obtained.

While the present invention has been particularly shown and described with reference to a preferred embodiment, it will be understood by those skilled in the art that various changes in form and detail may be without departing from the spirit and scope of the present invention.

What is claimed is:

1. A slide mobile camera phone, which comprises:
a display part comprising a viewing side and a joining side, wherein the joining side further comprises a camera lens; and
an operation part comprising an operating side, a back side and a set of zoom lenses, wherein the joining side is able to slide on the back side so that the display part and the operation part either essentially totally or partially overlap;
wherein if the display part and the operation part partially overlap, then the camera lens is configured to capture images directly; and if the display part and the operation part essentially totally overlap and the camera lens overlaps the set of zoom lenses, then the camera lens is configured to capture images after zooming via the set of zoom lenses.

2. The slide mobile phone of claim 1, wherein the camera lens is a CCD lens.

3. The slide mobile phone of claim 1, wherein the camera lens is a CMOS lens.

4. The slide mobile phone of claim 1, wherein the set of zoom lenses comprise a convex lens.

5. The slide mobile phone of claim 1, wherein the set of zoom lenses comprise a composite converging lens.
